(19) United States
(12) Patent Application Publication
(10) Pub. No.: US 2009/0327288 A1
(43) Pub. Date: Dec. 31, 2009

(54) CONTENT ENUMERATION TECHNIQUES FOR PORTABLE DEVICES

(75) Inventors: Andrew L. Silverman, Redmond, WA (US); Yasser B. Asmi, Redmond, WA (US); Bruno K. da Costa, Redmond, WA (US); Dennis Kiilerich, Seattle, WA (US); Jordan B. Naftolin, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,074

(22) Filed: Jun. 29, 2008

(51) Int. Cl. G06F 17/30

(52) U.S. Cl. 707/6; 707/E17.014

(57) ABSTRACT

Arrangements and techniques for enumerating portable device contents via a content management device are discussed herein. The portable device is caused to create and store a first data structure, referred to herein as a portable database, corresponding to the contents of a media library stored thereon. Upon connection to a content management device, the portable database is copied to the content management device, and is used in conjunction with information stored by the content management device in a second data structure, referred to herein as a device content table, to efficiently enumerate and provide other manipulation of the contents of the media library stored on the portable device.

### BACKGROUND

As digital media technology improves and the price of storage decreases, users increasingly host collections of digital media (for example, audio, video, images, graphics, and like) on their personal computers and/or network-based data storage services. But users often desire for their digital media collections to be portable. More and more, users seek to transfer all or some of their collections to portable devices. Examples of portable devices include but are not limited to personal media players, personal digital assistants, phones, portable computers, in-vehicle devices, and other devices.

With the advent of relatively high capacity storage on portable devices, users can store large quantities of media content on their portable devices. In many cases, however, users wish to view the contents of a portable device using a content management device such as a computer, server, or other device, rather than the portable device itself, to take advantage of richer user interfaces, advanced query/filtering capability, and the like. In addition, content management devices may facilitate adding fresh digital media to portable devices.

Viewing and transferring media files between a content management device and a portable device is often performed using media transfer protocol (“MTP”). MTP is a standard for communicating any type of multimedia data between a content management device and a portable device. MTP communicates both the file itself as well as metadata about that file, e.g. for music files: the title of the track, the name of the artist, the album name, and the like. In the MTP standard, to transfer a file, an object is created, and metadata properties are applied to the object. The metadata is transferred first, including the file size. If the receiving device determines that there is space to hold the file, the file content is transferred from the transferring device to the object.

The MTP standard works adequately for transferring files to a portable device. When used by a content management device for enumerating content on the portable device, however, use of the MTP standard may be frustratingly slow for a user, because MTP does not have any optimized capability to query the overall content of the device for items matching a particular set of criteria, and the entire contents of the device are enumerated. Such enumeration generally requires many round-trip transactions with the device, and subsequent searches of the results. A user's wait may be exacerbated if many content changes were made outside of the relationship between the portable device and the content management device, and/or if the connection between the content management device and the portable device is of low quality, bandwidth, and/or speed.

### SUMMARY

The arrangements and techniques discussed herein are used to efficiently enumerate and provide user access to the contents of portable devices via content management devices. A portable device is caused to create and store a data structure, such as a portable database, corresponding to the contents of a media library stored thereon. Specifically, in one exemplary implementation, the portable database includes objects corresponding to content items stored on the portable content device (content items stored in a media library, for example). Each object has a corresponding object identifier, and stores, among other things: a particular content item or reference thereto; certain metadata associated with the particular content item (generally metadata that consumes minimal storage space, such as title, artist, album name, duration, and the like); and optionally a global identifier associated with the content item.

When the portable device is connected to a content management device (as part of a synchronization operation, for example), the portable database is identified by (for example, copied to) the content management device. The content management device accesses a separate data structure, such as a device content table, which is used in conjunction with examination of objects in the portable database, to facilitate enumeration, searching, and other file manipulation of portable device contents by the content management device, in a more robust and efficient manner than may be achieved via the use of MTP or other item-by-item communication techniques. In a specific exemplary implementation, the contents of the portable database are imported directly into the device content table, and the device content table is stored in a format (such as a database format) that can be efficiently queried.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 illustrates a simplified functional block diagram of an arrangement for enumerating portable device contents on a content management device.

FIGS. 2(A)-(C) illustrate sequential views of an arrangement for displaying portable device contents on a content management device, showing how a portable database is transferred to a content management device.

FIG. 3 is a flowchart of one method for displaying portable device contents on a content management device.

FIG. 4 is a simplified functional block diagram of an exemplary configuration of an operating environment in which arrangements and/or methods for enumerating portable device contents on a content management device may be implemented or used.

### DETAILED DESCRIPTION

A content management device is configured to retrieve from a portable device a certain data structure, referred to for discussion purposes as a portable database, which includes a number of objects storing information about the media content within the portable device. The portable database is used in conjunction with a data structure maintained by the content management device or a separate device, referred to for discussion purposes as the device content table, to facilitate the efficient enumeration, searching, and other file manipulation of portable device contents by the content management device, without relying on MTP or other communication techniques to retrieve such contents.

The following terms and definitions are provided as an initial matter.

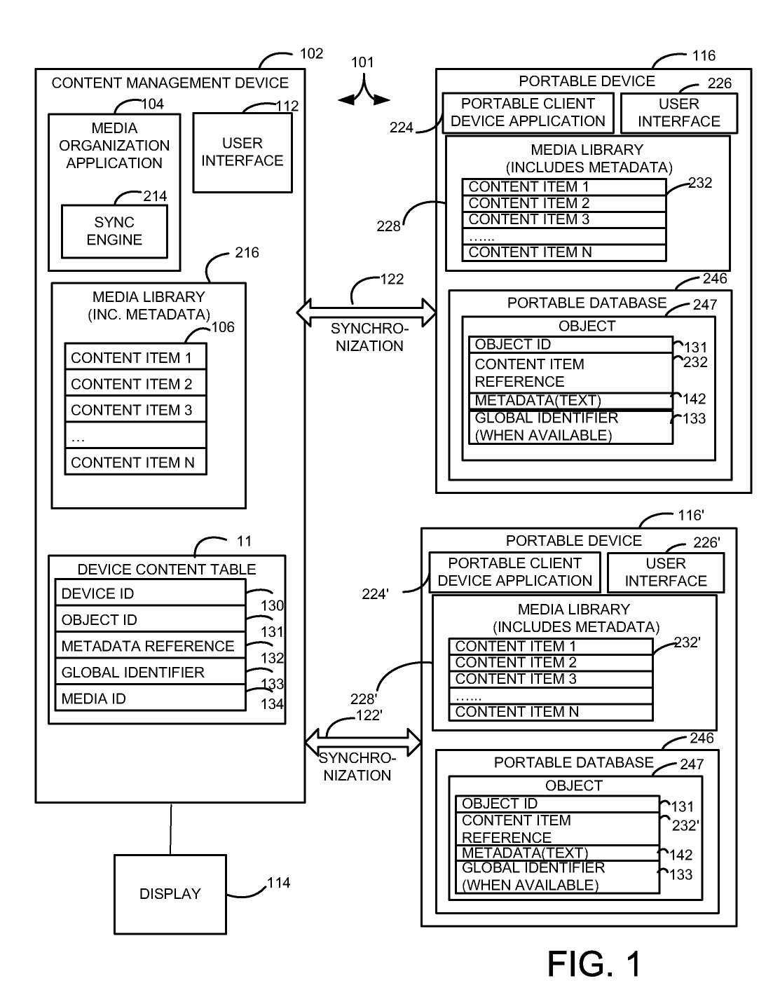

“Content items” (such as elements 106, 232, and 232′ shown in FIG. 1 and discussed further below), “items of content”, or just “content” represent any known or later developed commercial or non-commercial stored digital content (for example, files corresponding to audio, video, images, graphics, text, playlists, and the like) in any known or later developed format. Content items may also include episodic content made up of individual content files and/or any other known or later developed syndication format. Content items may be protected by one or more enforceable intellectual property rights of one or more third parties, such as copyrights, patent rights, trademark rights, or trade secret rights. It is to be appreciated and understood that content items can be embodied on any suitable computer-readable medium.

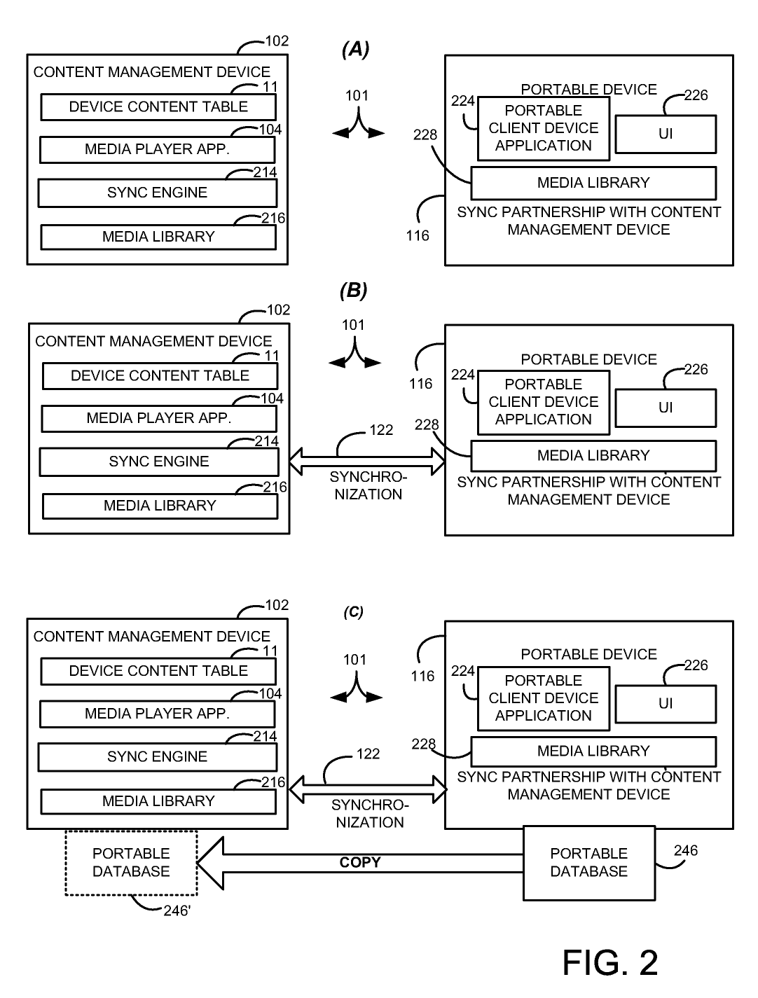

A “portable device” (such as elements 116, 116′ shown in FIGS. 1-2 and discussed further below) is any device that can store and/or render content items. Some ability to manage the content items thereon is usually accorded, such as the ability to delete a content item or to add to or modify a playlist. However, in many cases, such functionality is minimal as users prefer to manage their content on a device where the content items may be more easily visualized, such as a “content management device” described below. An exemplary portable device is a portable and/or in-vehicle media player, phone, personal digital assistant, computer, and the like. A portable device may also be any network-connected device capable of interacting with a network-based application or device (for example, a content management application such as a Web service, discussed below)

A “content management device” (such as element 102 shown in FIGS. 1-2 and discussed further below) is any device with functionality to enumerate and/or manage content items. A content management device may also render content items. While an exemplary content management device discussed here is a personal computer, the arrangement may be employed with any computing device, such as desktop computers, servers, laptop or notebook computers, handheld computers, personal digital assistants, smartphones, mobile phones, tablet computers, mainframe computers, and the like. A content management device may also be an application, such as a Web service, running on a networked server, or any network-connected device capable of interacting with a network-based application. A user interface may be provided by a Web page, an application running on a device that connects to the Web service, or any other suitable network-connected device.

“Synchronization” (such as via transfer interface 122 or via a synchronization link 122′ shown in FIG. 1 and discussed further below), refers to the act of making two sets of content items on each of two different devices, whether content management devices or content playback devices, correspond to each other. The two sets need not be identical; rather, the correspondence is generally to add or delete content items on both, or to manage content items on both. In many cases, content is managed on a content management device and the managed content is periodically synchronized with a portable device that a user carries as part of the user's daily routine. In many cases, content management devices can store much more information than portable devices, and thus it is a subset of content items on a content management device that is synchronized with a portable device. Content management devices may also synchronize with other content management devices—this may occur, e.g., if a user synchronizes content downloaded from an online service to a mobile phone, and then synchronizes the mobile phone to another content management device. Synchronization may be partial; that is, only a portion of the content on one device may be synchronized to another device. This may occur, e.g., when only certain playlists are synchronized, or when a synchronization was interrupted before it was completed (by user action, or because of a lost connection, for example). The synchronization procedure may be automatic or manual. While the term “synchronization” refers to data and information flowing in both directions between a content management device and a portable device, the term often relates to simply downloading items from a content management device to a portable device.

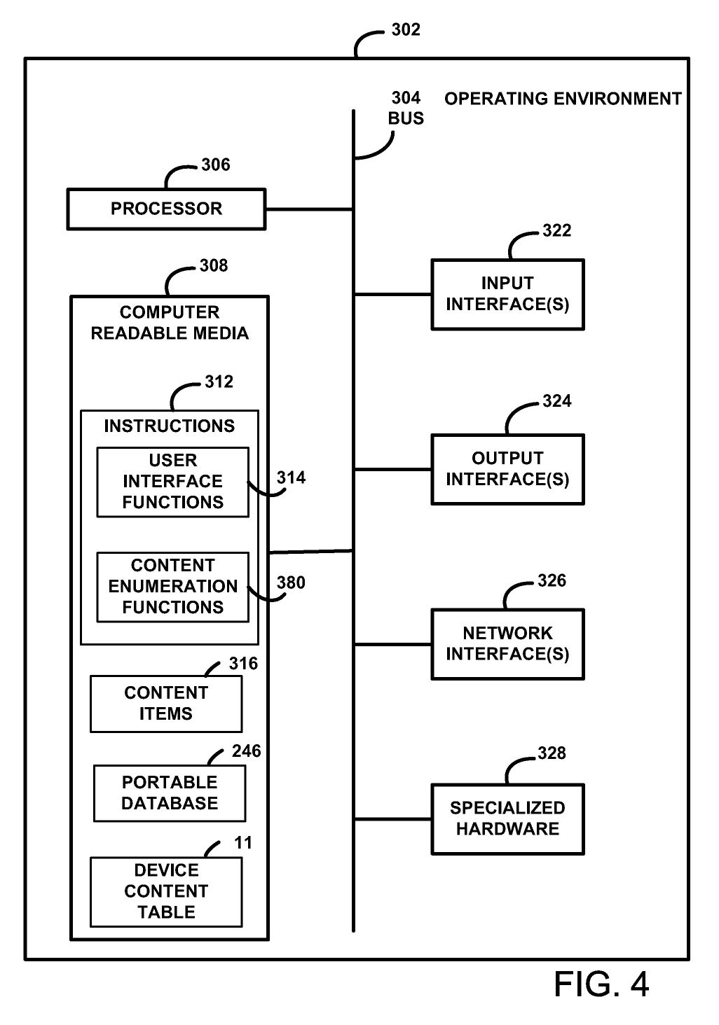

Turning now to the drawings, where like numerals designate like components or steps, FIG. 1 illustrates a simplified functional block diagram of an exemplary arrangement 101 for enumerating contents of one or more portable devices 116, 116′, using a content management device 102. As shown, content management device 102 includes a media organizing application, such as a media player application 104. Application 104 may be a rendering filter or program that is configured to organize and/or render digital media. Executing media player application 104 in the illustrated arrangement allows a user to access one or more of a number of digital media files 106 (shown as content item 1, content item 2, and so on) which may be part of a media library 216 stored on any known or later developed a computer-readable medium (computer-readable media 308 are discussed further below, in connection with FIG. 4). The media player application 104 may also be configured, if so desired, to access, retrieve, store, and display metadata associated with a media file for the user. Metadata is information about data. In the context of the content items, metadata involves information related to the specific contents of the digital media files 106 organized, stored, and/or rendered via media player application 104. Metadata includes, for example, one or more of album title, artist, performer, genre, description of content, and the like, and may be in the form of audio, video, text, graphics, images, and the like, similar to content items.

In this context it is noted that the content management device may also include computer-readable instructions for operating the media player application 104, the sync engine 214, the user interface 112, and numerous other applications within the content management device 102.

The media player application 104 includes a graphical user interface 112 for displaying media files 106 and/or organized metadata to the user on a display 114. The UI 112 may also be used to assist the user in transferring media files 106 to a remote device such as a portable device 116 or 116′ communicatively connected to the computer 102 via transfer interface 122 or 122′, respectively. The UI 112 may also display contents of the portable device directly. In the arrangement described below, this is performed in a rapid fashion by use of a portable database. The portable database is formed on the portable device and transferred to the content management device for rapid searching or other operations.

The content management device 102 executes a target device storage sync manager program module, or synchronization engine 214, embodied on one or more processor-readable media (such as a computer storage or memory) and implemented as part of multimedia software product, an operating system, or a dedicated multimedia appliance. The exemplary target device storage sync manager provides a user-configurable model for facilitating automatic transfer of all or a subset of a user's digital collection to the target, portable device 116, from the source, content management device 102.

A transfer interface 122 couples portable device 116 to content management device 102. This physical interface may be any known or later developed wired or wireless medium. Examples of a wired interface include USB, USB2, IEEE 1394, IEEE1284 (“parallel” connection), RS-232 Serial connection, and/or Ethernet, Token Ring, and similar networks. Examples of a wireless interface include Bluetooth; Infra-Red (IR); 802.11a, b, or g; GPRS, CDMA, EVDO, EDGE, and other related wireless telephony data-transmission standards. In some implementations, the interface 122 may provide for data transfer over a short distance (e.g., measured in a few feet) or over a long distance (e.g., measured in miles).

The transfer from content management device 102 to portable device 116 (and vice versa) is termed “synchronization” (or simply “sync”). As the collection on the source device changes (e.g., as items are removed or added, and/or item priority changes), the subset of the collection which is stored on the target device changes with each synchronization. Changes on the portable device likewise affect synchronization results, directly or indirectly. For example, assume that a user has previously synced a podcast series to his device, but after listening, decides to “unsubscribe” via an “unsubscribe” option offered on the device. The user request to unsubscribe is communicated to the content management device during synchronization, and the content management device is caused to remove that podcast series from the device, and to stop updating it in the future. Items in the media library of the content management device are identified with the aid of a data structure referred to herein as device content table 11. The device content table stores information that can be used to identify particular content items uniquely (in addition to various other information used for the synchronization process), including but not limited to: an object identifier (“object ID”) 131, which identifies a particular object 247 (discussed further below) within portable database 246, and is generated by a portable device and returned to the content management device; a device identifier (“device ID”) 130, which may be used in the event a particular user synchronizes with multiple devices; and a media identifier (“media ID”) 134, which is an identifier (such as a number) assigned to a content item as it is added to the media library of the content management device. Information about the content items themselves, such as a metadata reference 132, which is a reference (such as a pointer, a vector, or a URL) to one or more storage locations for metadata related to a particular content item (such as album metadata, artist metadata, track number, duration, and the like); and a global identifier 133 (referred to herein as the service media ID), which is generally (but not necessarily) the same for anyone who has the same content item, may be stored or referenced by device content table 11 or another data structure (such as a table) within the content management device. In one exemplary implementation, content items in the media library of the content management device are themselves stored in different tables, depending on type (track, video, photo, and the like). The information about the content items themselves, such as metadata reference 132 and/or global identifier 133, may be present on the table used for that particular type of content item (for example, the track table, the video table, the photo table, and the like). The media ID 134, the device ID 130, and the object ID 131 are used to associate particular content items to a particular portable device.

The portable devices 116 and 116′ include portable device applications 224 and 224′, user interfaces 226 and 226′, and media libraries 228 and 228′ having contents 232 and 232′, respectively. The portable device applications 224 and 224′ provide the functionality of the portable devices 116 and 116′, and the media libraries 228 and 228′ store the content items placed thereon. The user interfaces 226 and 226′ display information such as media lists, playlists, track information, and the like. The portable device 116 is shown as connected to the content management device 102 via a transfer interface 122, while the portable device 116′ is shown as connected to the content management device 102 via a transfer interface 122′. One or more persistent or temporary computer-readable media (not shown) may store the contents of a data structure, referred to herein as a portable database 246. Also stored in computer-readable media are contents of the media libraries, and any client-side applications.

In one exemplary implementation, portable database 246 stores a number of objects 247, with a particular object having an object identifier (“object ID”) 131 and storing, among other desired items, the following: a reference to a particular content item stored on a portable device (such as a pointer to the item's ID), metadata 142 associated with the particular content item (generally, metadata 142 is text-based, to minimize storage space, although any type of metadata is possible), and a global identifier field 133, configured to store a globally unique identifier (referred to herein as a “service media ID”), that is generally (but not necessarily) the same for anyone who has the same content item. A media identifier 134 (not shown in connection with portable database 246 but shown in connection with device content table 11), which may be generated by a particular content management device, may also (but need not be) be stored by object 246.

As shown, the portable device 116 has set up a synchronization partnership with the content management device 102. That is, the portable device 116 is registered with the content management device 102 and periodic synchronizations result in the media library 216, or a selected portion thereof, being placed onto the portable device 116. Manipulations of the files on one, such as additions, deletions, inclusion in a playlist, or the like, are reflected in the other upon synchronization. It is possible for transcoding to occur during synchronization, which would cause an alternative representation of a particular content item to be stored, instead of the original. Even so, the content representations would have the same media identifer.

On the other hand, the portable device 116′ has not set up a synchronization partnership with the content management device 102; rather, the portable device is a guest device. That is, the content management device 102 may be employed to view and manipulate content items on the portable device 116′, but the same is not set up to synchronize with a media library that is associated with the media library on the content management device. Both types of portable device setups may enjoy the benefits of the arrangement. Even portable devices that have set up a partnership with a content management device may nevertheless connect to a content management device as a guest, either with the content management device for which a partnership is had or with another content management device, e.g., that of a friend.

In one exemplary implementation, when a synchronization or other connection occurs, the following events take place. Each item (and/or track thereof) designated for transfer from the content management device to the portable device is sent to the portable device along with certain metadata and the Service Media ID. The portable device returns an “object ID” to the content management device. The object ID is an identifier that refers to the specific object just created on that specific portable device for the content item. In an exemplary implementation, because the object ID returned by the portable device is only valid for that specific portable device, the device ID (for example, the serial number of the portable device) is also stored, for later identification. The item itself as well as its metadata belong to the object, as properties of the object. The device content table is updated to reflect the following information: the device ID (in case the user has multiple devices); the object ID just returned from the device; the media ID (also described below) of the item that was sent; and various other information used for the sync process. As a result, there is a clear link between a given object on the device and a local media id of what that item is. By looking up the media ID in the content management device database, generally any information can be found about a content item and its metadata.

FIG. 2 shows an exemplary connection sequence between the content management device 102 and the portable device 1 16. A similar description will be understood to apply in the case of portable device 116′. Many of the same elements are as shown in FIG. 1 and the same are not described in detail in connection with FIG. 2.

As shown in FIG. 2(A), no connection between the content management device 102 and the portable device 116 has yet been made. In FIG. 2(B), a connection has been made, as shown by the transfer interface 122. If the portable device 116 has not yet been powered on, in many cases, the connection of a link will cause the portable device to power on. Once powered on, a portable database 246 is loaded into the memory of the portable device. If the portable database 246 has previously been created, it is loaded from a storage device, such as a semiconductor memory or hard drive on the portable device 116. In particular, if the portable database 246 has not previously been created, it is created by the portable device application 224 and then loaded into memory, assuming the portable device application 224 is configured to create a portable database. Once loaded into memory, the portable database 246 is transferred to the content management device 102 as a single file. The copy of the portable database 246 is shown in FIG. 2(C) as portable database 246′. The portable database 246 is generally a well-optimized database which is small enough to reside entirely in memory, so undue hard disk operations, often taxing on speed and battery life, may not be necessary.

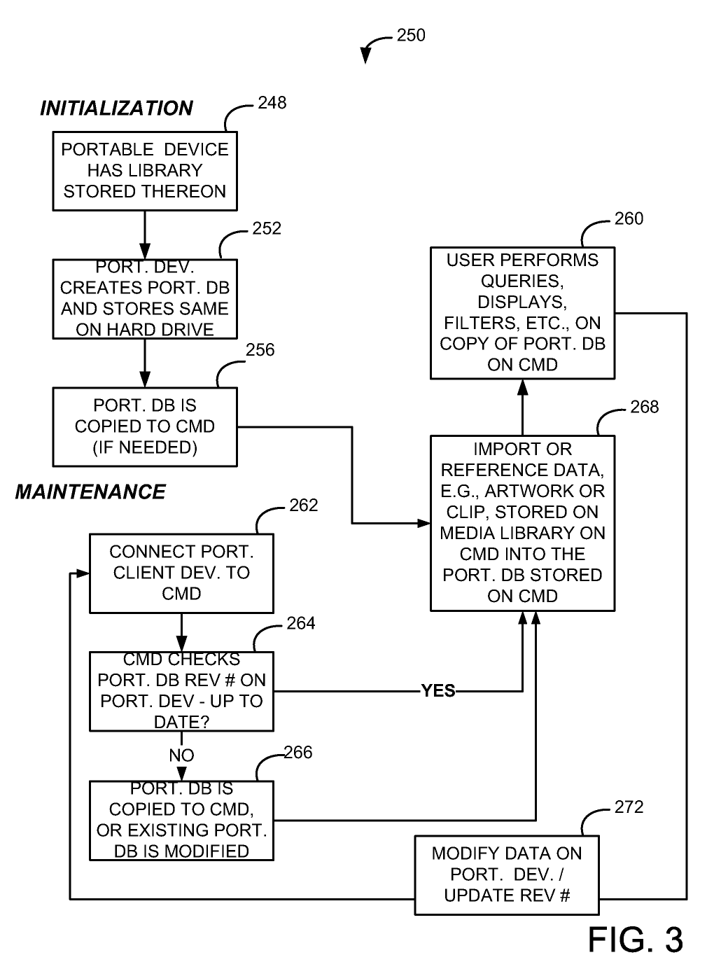

With continuing reference to FIGS. 1 and 2, FIG. 3 is a flowchart 250 of a method for displaying portable device contents on a content management device. The method shown in FIG. 3 may be implemented in one or more general, multi-purpose, or single-purpose processors, such as processor 306 shown and discussed further below in connection with FIG. 4. Aspects of the illustrated method may be performed by networked server(s)/service(s) or client-side devices. Unless specifically stated, the method is not constrained to a particular order or sequence. In addition, some of the described steps or elements thereof can occur or be performed concurrently.

A starting point is that the portable device has a media library stored thereon (step 248). A next step is that the portable device creates a portable database and stores the portable database (step 252). A next step, if necessary, is that the portable device is powered on, and the portable database is loaded into its memory. The portable database from the portable device is then copied onto the content management device (step 256), if necessary (discussed further below). In an exemplary implementation, the portable database is transferred from the portable device over MTP (as a snapshot), but not mounted, so the portable device remains in MTP mode, and is still operational while the portable database is being transferred. Mounting the portable database directly inhibits the device's ability to perform normal operations while the db is in the mounted state. This completes an initialization phase of the arrangement, and flow can proceed to step 268.

In a maintenance phase, the portable device is connected to a content management device (step 262). The content management device checks the revision identifier of the portable database (step 264). The revision number is generally incremented on both the portable device and the content management device with each transferred file. If the revision number of the portable database is the same as the latest known revision on the content management device, there is generally no need to transfer the portable database to the content management device. If the portable database is up-to-date, i.e., if the portable database on the content management device matches the portable database on the portable device (the YES branch), then the flow can proceed to step 268. If the revision identifiers do not match, there are various conditions under which revision identifiers would not match. Most commonly, revision identifiers do not match because the portable device contents were modified by another computer (or other state changes on the portable device occurred) when the portable device was connected as a guest to another computer (for example, content was downloaded from a network such as the Internet or from another device.) In that case, content transferred to the portable device caused the revision number to be incremented on the portable device, and it got out of sync with the revision number on the content management device portable device The two revision numbers may be caused to match, either by copying a new portable database to the content management device or by modifying the existing portable database on the content management device (step 266). The flow next proceeds to step 268.

The portable database copied onto the content management device is generally a subset of the database contents of the content management device, which has fewer constraints in available long-term storage and short-term memory. As such, the portable database may not be able to hold clips, artwork, or other more extensive metadata. So when a report is made of the portable database, e.g., the contents of the portable device is rendered in the form of a table or other report, the report may generally not include such features. Even so, the usage of media identifiers and Service Media IDs will allow the more extensive metadata to be retrieved, either locally on the content management device, or from a network service. The case where metadata is so retrieved or referenced is indicated in step 268. It is also noted that the portable database may also expose metadata to the content management device that is not otherwise accessible via regular MTP.

One type of media identifier that may be employed is the “media ID” tag. This identifier is local to the content management device's database and is unique within that context. Even within this unique identifier, an item may have several associated files, e.g., an AAC version, a WMA version, and so on. During the synchronization procedure, there may be an algorithm employed to determine which file is preferred, e.g., an unprotected file may take precedence over a DRM-protected one, and so on.

Another type of media identifier that may be employed is the “service media ID” tag. When the item is added to the library for the first time, an attempt is made to see if there exists a service media ID. If none exists, an attempt may be made to look up the service media ID in a number of network-based databases, using other metadata, e.g., text metadata like album and artist. If this returns a match, then a unique identifier may be retrieved, i.e., a globally unique identifier or GUID. This GUID may then be written back to the database and the original file. Such an identifier is intended to be the same for anyone who has the same item in his library. When content items are obtained from an online service, the service media IDs are generally included with the transfers of the content items.

In an exemplary implementation, each object in the transferred portable database is inspected one-by-one. If the object ID of the item already exists in the device content table on the content management device, then the content management device already has stored all the information necessary about the content item on the portable device and thus no new entry is required. In this case, the content management device was the device which sent the content to the portable device originally. If the object ID of the item being inspected is not in the device content table, then the content was added to the portable device by another content management device or in some other fashion, or in some cases the content management device's database has been lost and is being rebuilt, and thus the relationships between the portable device and the content management device are lost and need reconstruction. In that case, more information is needed about the item. To start, the content item in the copied portable database may be checked to determine if the same has a Service Media ID. If it does, the Service Media ID may be looked up in the PC's local database. If it exists, there is a matching item that is the same as the one on the device. In this case, the local Media ID may be retrieved containing that Service Media ID, and the item may be added to the device content table along with its object ID and local media ID. The link between the local content and the portable device has now been recreated. If there is no service media ID for the item in the portable database, then the algorithm may attempt to find a match in the local library based on the textual metadata such as the combination of album, artist, track name, and duration. This is a “fuzzy” algorithm that weights the different fields and tries to determine if an acceptable match exists. If such a match to local content exists, then once again a row in the device content table is created with the object ID from the portable device and the local media ID that it appears to match. If no match is found, a new row in the corresponding media table on the content management device is created. The (local) media ID of that new row is then used in the new device content table row. This allows a generic representation of the object to be displayed on the content management device, e.g., so that it can be deleted by the user from the device. However, any metadata not available directly from the portable database, such as an album art thumbnail, may not be available for display. In one exemplary implementation, a special task may run from time to time to identify content items with missing metadata, and locate the metadata in a network-based service.

A last step is that the user may perform queries, displays, filters, and so on, on the portable database transferred to the content management device (step 260). In some cases, querying on the content management device may not only be of the transferred portable database but also of the contents of the media library 216. In any case, the speed of searching and other manipulations on the content management device may be imparted to searching and manipulating contents on the portable device. It will also be appreciated that rapid enumeration features and techniques described herein are not only useful to display information to a user, but are also usable to determine what has changed, and what needs to be synchronized, to a particular device.

The arrangements and techniques described herein provide a convenient and rapid way to display contents of a portable device via a content management device. While the above description has primarily focused on setup of a portable database, or use of a previously-setup portable database, other implementations are also possible. For example, a content management device may be programmed such that, upon connection of a content management device to a portable device, where the portable device has not previously set up a portable database, the content management device automatically causes the portable device to set up a portable database. The portable database may then be copied or transferred onto the content management device.

FIG. 4 is a block diagram of an exemplary configuration of an operating environment 302 (such as a client-side device or application or a networked server or service) in which all or part of the arrangements and/or methods shown and discussed in connection with the figures may be implemented or used. Operating environment 302 is generally indicative of a wide variety of general-purpose or special-purpose computing environments, and is not intended to suggest any limitation as to the scope of use or functionality of the arrangements described herein.

As shown, operating environment 302 includes processor 306, computer-readable media 308, and computer-executable instructions 312. One or more internal buses 304 may be used to carry data, addresses, control signals, and other information within, to, or from operating environment 302 or elements thereof.

Processor 306, which may be a real or a virtual processor, controls functions of the operating environment by executing computer-executable instructions 312. The processor may execute instructions at the assembly, compiled, or machine-level to perform a particular process.

Computer-readable media 308 may represent any number and combination of local or remote devices, in any form, now known or later developed, capable of recording, storing, or transmitting computer-readable data, such computer-executable instructions 312, including user interface functions 314 and content enumeration functions 380, as well as content items 316, portable database 246, and/or device content table 11. In particular, the computer-readable media 308 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof The computer-readable media may also include transmission media and data associated therewith. Examples of transmission media/data include, but are not limited to, data embodied in any form of wireline or wireless transmission, such as packetized or non-packetized data carried by a modulated carrier signal.

Computer-executable instructions 312 represent any signal processing methods or stored instructions. Generally, computer-executable instructions 312 are implemented as software components according to well-known practices for component-based software development, and are encoded in computer-readable media. Computer programs may be combined or distributed in various ways. Computer-executable instructions 312, however, are not limited to implementation by any specific embodiments of computer programs, and in other instances may be implemented by, or executed in, hardware, software, firmware, or any combination thereof.

Input interface(s) 322 are any now-known or later-developed physical or logical elements that facilitate receipt of input to operating environment 302.

Output interface(s) 324 are any now-known or later-developed physical or logical elements that facilitate provisioning of output from operating environment 302.

Network interface(s) 326 represent one or more physical or logical elements, such as connectivity devices or computer-executable instructions, which enable communication between operating environment 302 and external devices or services, via one or more protocols or techniques. Such communication may be, but is not necessarily, client-server type communication or peer-to-peer communication. Information received at a given network interface may traverse one or more layers of a communication protocol stack.

Specialized hardware 328 represents any hardware or firmware that implements functions of operating environment 302. Examples of specialized hardware include encoders/decoders, decrypters, application-specific integrated circuits, clocks, and the like.

The methods shown and described above may be implemented in one or more general, multi-purpose, or single-purpose processors.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A method for exposing information about content items stored on a portable device, the method comprising:
upon connection between a portable electronic device and a content management device, accessing a first data structure provided by the portable device, the first data structure storing a number of objects, each object having an object identifier, each object having properties for storing
a reference to a particular content item stored on the portable electronic device or the particular content item itself or both,
metadata associated with the particular content item, and
a global identifier field, for storing a global identifier associated with the particular content item, when the global identifier is known by the portable electronic device;
accessing a second data structure provided by the content management device, the second data structure storing
at least some of the object identifiers corresponding to objects stored in the first data structure,
a number of global identifiers corresponding to content items stored by the content management device, and
references to metadata associated with content items, the metadata or the content items or both stored by the content management device, the association of metadata and content items established via the object identifiers, the global identifiers, or both;
identifying a particular object within the first data structure, the particular object associated with a particular content item stored by the portable electronic device;
within the first data structure, identifying the object identifier of the particular object;
attempting to locate the object identifier within the second data structure;
when the object identifier is located within the second data structure, using the object identifier to identify within the second data structure a reference to metadata associated with the particular content item, and using the reference to metadata to retrieve the metadata from the content management device;
when the object identifier is not located within the second data structure, determining whether the global identifier field of the object stores a global identifier associated with the particular content item;
when the global identifier field does not store a global identifier, retrieving the metadata associated with the particular content item from the first data structure;
when the global identifier field stores a global identifier, attempting to locate the global identifier within the second data structure;
when the global identifier is located within the second data structure, using the global identifier to identify within the second data structure a reference to metadata associated with the particular content item, and using the reference to metadata to retrieve the metadata from the content management device;
when the global identifier is not located within the second data structure, either retrieving the metadata associated with the particular content item from the first data structure, or retrieving the metadata associated with the particular content item from a remote location using the global identifier;
when the object identifier is not located within the second data structure, and when the global identifier field does not store a global identifier, retrieving the metadata associated with the particular content item from the first data structure; and
presenting the retrieved metadata to a user via the content management device.

2. The method according to claim 1, wherein the first data structure comprises a portable database.

3. The method according to claim 1, wherein the second data structure comprises a device content table maintained by the content management device or a network-based server or both.

4. The method according to claim 1, wherein the metadata within the first data structure comprises text-based metadata, and wherein the metadata stored by the content mangement device or the network-based server or both is selected from the group comprising: audio, video, text, images, and graphics.

5. The method according to claim 1, further comprising:
repeating the steps of identifying a particular object within the first data structure through presenting the retrieved metadata to a user, for each object within the first data structure.

6. The method according to claim 1, wherein the method further comprises, after the step of using the global identifier to identify within the second data structure a reference to metadata associated with the particular content item, and using the reference to metadata to retrieve the metadata from the content management device,
within the second data structure, adding an association of the object identifier with the global identifier.

7. The method according to claim 1, wherein the method further comprises, when the global identifier is not located within the second data structure, after either retrieving the metadata associated with the particular content item from the first data structure, or retrieving the metadata associated with the particular content item from a network-based location using the global identifier,
within the second data structure, adding the retrieved metadata, the object identifier, and the global identifier, and an association therebetween.

8. The method according to claim 1, wherein when the object identifier is not located within the second data structure, and the global identifier field does not store a global identifier, the step of retrieving the metadata associated with the particular content item from the first data structure comprises
identifying the metadata from the first data structure,
using a predetermined algorithm, attempting to locate a corresponding metadata reference within the second data structure,
when a corresponding metadata reference is located within the second data structure, based on the corresponding metadata reference, retrieving the corresponding metadata from the content management device, and within the second data structure, adding the object identifier corresponding to the metadata reference, and
when a corresponding metadata reference is not located within the second data structure, retrieving the metadata from the first data structure.

9. The method according to claim 1, further comprising:
upon identifying the first data structure, identifying a revision identifier associated with the first data structure;
comparing the revision identifier with a previously received revision identifier stored in a first memory location accessible by the content management device;
based on the step of comparing, determining whether to copy the first data structure to a second memory location accessible by the content management device.

10. The method according to claim 9, wherein when a change is detected between the revision identifier and the previously identified revision identifier, the method further comprises:
copying the first data structure to the second memory location accessible by the content management device.

11. The method according to claim 9, wherein when a change is detected between the revision identifier and the previously identified revision identifier, the method further comprises:
determining whether a time stamp associated with the first data structure on the portable electronic device or a time stamp associated with the first data structure on the content management device is latest in time, and modifying the first data structure that is not-latest in time to match the first data structure that is latest in time.

12. The method according to claim 1, wherein the method is performed by a client-side device or a server-side device.

13. The method according to claim 1, wherein the connection forms part of a synchronization operation between the portable electronic device and the content management device.

14. A computer-readable storage medium encoded with computer-executable instructions which, when executed by a processor associated with a content management device, perform a method comprising:
causing a portable device to parse a library of media content items stored thereon, and to retrieve at least a subset of a plurality of metadata associated with each content item;
causing the portable device to create a portable database and to store the retrieved metadata into the portable database; and
causing the portable device to make the portable database available to a content management device upon connection of the portable device to the content management device.

15. The computer-readable storage medium according to claim 14, wherein the processor comprises a client-side processor or a server-side processor.

16. The computer-readable storage medium according to claim 14, wherein the connection comprises a synchronization operation.

17. The computer-readable storage medium according to claim 14, wherein the method further comprises:
associating a revision identifier with each revision of the portable database, and making available to the content management device, upon connection, the revision identifier of the portable database.

18. The computer-readable storage medium according to claim 14, wherein the step of causing the portable device to make the portable database available includes making a copy of the portable database on the content management device, or transferring the portable database to the content management device.

19. An electronic device, comprising:
a computer-readable storage medium; and
a processor responsive to the computer-readable storage medium and to a computer program, the computer program, when loaded into the processor, operable to perform a method comprising
identifying a first data structure provided by a portable device, the first data structure storing a number of objects, each object having an object identifier, each object having properties for storing
a reference to a particular content item stored on the portable electronic device, or the particular content item itself, or both,
metadata associated with the particular content item, and
a global identifier field, for storing a global identifier associated with the particular content item, when the global identifier is known by the portable electronic device,
identifying a second data structure not maintained by the portable electronic device, the second data structure storing
at least some of the object identifiers corresponding to objects stored in the first data structure,
a number of global identifiers corresponding to content items stored by the content management device, and
references to metadata associated with content items, the metadata or the content items or both stored by the content management device, the association of metadata and content items established via the object identifiers, the global identifiers, or both,
identifying a particular object within the first data structure, the particular object associated with a particular content item stored by the portable electronic device,
within the first data structure, identifying the object identifier of the particular object,
attempting to locate the object identifier within the second data structure,
when the object identifier is located within the second data structure, using the object identifier to identify within the second data structure a reference to metadata associated with the particular content item, and using the reference to metadata to retrieve the metadata from the content management device,
when the object identifier is not located within the second data structure, determining whether the global identifier field of the object stores a global identifier associated with the particular content item,
when the global identifier field does not store a global identifier, retrieving the metadata associated with the particular content item from the first data structure,
when the global identifier field stores a global identifier, attempting to locate the global identifier within the second data structure,
when the global identifier is located within the second data structure, using the global identifier to identify within the second data structure a reference to metadata associated with the particular content item, and using the reference to metadata to retrieve the metadata from the content management device,
when the global identifier is not located within the second data structure, either retrieving the metadata associated with the particular content item from the first data structure, or retrieving the metadata associated with the particular content item from a remote location using the global identifier,
when the object identifier is not located within the second data structure, and when the global identifier field does not store a global identifier, retrieving the metadata associated with the particular content item from the first data structure, and
presenting the retrieved metadata to a user.

20. The electronic device according to claim 19, wherein the electronic device comprises a client-side device or a network-side device.
